(19) United States
(12) Patent Application Publication
(10) Pub. No.: US 2015/0300834 A1
(43) Pub. Date: Oct. 22, 2015

(54) NAVIGATION APPARATUS HAVING LANE GUIDANCE FUNCTION AND METHOD FOR PERFORMING THE SAME

(71) Applicant: Electronics and Telecommunications Research Institute, Daejeon (KR)

(72) Inventors: Ju Seok SHIN, Daejeon (KR); Sung Jae BYUN, Daegu (KR); Eun Ryung LEE, Daegu (KR); Kee Koo KWON, Daegu (KR); Soo In LEE, Daejeon (KR)

(21) Appl. No.: 14/515,123

(22) Filed: Oct. 15, 2014

(30) Foreign Application Priority Data
Oct. 15, 2013 (KR) 10-2013-0122615

(51) Int. Cl. G01C 21/36

(52) U.S. Cl. CPC G01C 21/3602

(57) ABSTRACT

Disclosed are a navigation apparatus having lane recognition function and a method for the same. The navigation apparatus may comprise an image acquisition part configured to acquire an image about lanes; and a control part configured to recognize a lane in which a vehicle on driving is located and to provide lane guidance information based on the recognized lane and a configured driving route. Thus, lane change guidance information can be provided in consideration of the number of lanes and distances between intersection points thereby enabling users to drive more stably and efficiently in complex areas.

### CLAIM FOR PRIORITY

This application claims priority to and the benefit of Korean Patent Application No. 10-2013-0122615 filed on Oct. 15, 2013 in the Korean Intellectual Property Office (KIPO), the entire contents of which is hereby incorporated by reference.

### BACKGROUND

1. Technical Field

Example embodiments of the present invention relate in general to navigation apparatuses and methods for the same, and more specifically, to navigation apparatuses having a lane guidance function which can provide convenience of route guidance and increase driving safety.

2. Related Art

Generally, a navigation apparatus is an apparatus which recognizes a current position of a vehicle in driving and provides a driver with information on an optimal route from the current position to a configured destination, traffic information, etc. by using sound and image. Since the late 1990s, the navigation apparatuses have been widely used in vehicles including personal vehicles as well as commercial vehicles.

Usual navigation apparatuses may comprise an input part configured to receive destination information from a user, a storage part storing an electronic map on which the route guidance function is performed based, a position recognition part configured to recognize a current position of a vehicle, a control part configured to determine an optimal route from the current position to the destination based on the current position recognized in the position recognition part and provide route guidance information based on the determined route, and an output part configured to provide the user with the route guidance information by using visual and sound information through a display device and a speaker.

Currently, as the input parts of navigation apparatuses, physical buttons or touch screen panels are being used. Also, due to their flexibility and immediacy, touch screen panels are being widely used as the input parts.

The electronic maps stored in the storage part have characteristics that they can store much information than conventional paper maps. That is, further detail geographical information and information on specific terrain features and shortest road information, etc. can be stored in the electronic maps. Also, various information such as longitude, latitude, address, telephone number, internet address, etc. can be included and in the electronic maps, and they may be utilized with the geographical information. In addition, the electronic maps and other information can be updated to latest information through internet communication technologies.

The position recognition part usually uses a Global Positioning System (GPS) system. The GPS is one of Global Navigation Satellite Systems (GNSS), which has been developed and operated by United States Department of Defense (DoD). In the GPS, a receiver measures exact time and distances from three or more artificial satellites, and calculates current position of the receiver by using triangulation method based on the three or more measured distances. The GPS receiver in the navigation apparatus may exist as included in the navigation apparatus or separated from the navigation apparatus, and may provide accuracy within 10 meters. In order to obtain more accurate position information, a differential GPS system (DGPS) which uses two receives and cancels out common errors of the receivers can be used. However, due to its high costs, it is not usually used.

Current navigation apparatuses can guide a fast route by using traffic condition such as average driving speeds in roads and provide safety driving information as well as usual route guidance information. Among the above additional information, there may be lane guidance information. Since the usual route guidance information provides only direction information in intersection or junction points, there may be problems that it does not provide enough information to inexperienced drivers or drivers on their first trips. The lane guidance information can resolve the above problems by further providing the user with information on lanes as well as the direction information.

However, since the navigation apparatus having the above-described lane guidance function provides detail lane guidance information unconditionally without consideration on driving experience levels of the drivers, there may be shortcomings that the guidance information cannot be provided to the inexperienced drivers at appropriate time and that excessive visual and sound guidance information unnecessary for experienced drivers may be provided thereby putting driver's attention in disorder.

Also, since exact positions of vehicles cannot be recognized due to errors of position information obtained from GPS system, guidance information cannot be provided at appropriate times in continuous intersection points or roads having complicates changes of lanes.

### SUMMARY

Accordingly, example embodiments of the present invention are provided to substantially obviate one or more problems due to limitations and disadvantages of the related art.

Example embodiments of the present invention provide a navigation apparatus which can provide more accurate and safe lane guidance information for a route to destination and guidance information optimized for driving experience levels of drivers.

Also, example embodiments of the present invention provide a method for providing lane guidance information in the above navigation apparatus.

In some example embodiment, a navigation apparatus may comprise an image acquisition part configured to acquire an image about lanes; and a control part configured to recognize a lane in which a vehicle on driving is located and to provide lane guidance information based on the recognized lane and a configured driving route.

Here, when the vehicle is located at a first distance from a first point in which a direction change is intended and the recognized lane is not a lane in which a direction change to a direction desired at the first point is possible, the control part may provide lane guidance information indicating a lane change to the lane in which the direction change to the direction desired at the first point is possible.

Here, the apparatus may further comprise an input/output part providing a user interface for receiving driving experience level information from a user according to control of the control part, wherein the first distance is determined according to the driving experience level information received through the input/output part. Also, the control part may determine the first distance corresponding to the driving experience level information based on at least one of an expected arrival time from a current position of the vehicle to the first point and a distance between the current position of the vehicle and the first point. Here, the control part may determine whether there are multiple lanes where the direction change to the direction desired at the first point is possible, and provide the lane guidance information indicating a lane change to a lane corresponding to a direction desired at a second point in which a next direction change is intended when there are multiple lanes where the direction change to the direction desired at the first point is possible. Also, the control part may determine whether a distance between the first point and the second point is less than a predetermined second distance, provide lane guidance information indicating a lane change to a lane corresponding to the direction desired at the second point when the distance between the first point and the second point is less than the second distance and there are multiple lanes where direction change to the direction desired at the first point is possible, and provide lane guidance information indicating a lane change to a lane corresponding to the direction desired at the first point when the distance between the first point and the second point is not less than the second distance and there is only one lane where direction change to the direction desired at the first point is possible.

In other example embodiment, a method for providing navigation information, the method may comprise acquiring an image about lanes; recognizing a lane in which a vehicle on driving is located from the image; and providing lane guidance information based on the recognized lane and a configured driving route.

Here, the providing lane guidance information may further comprise determining whether the vehicle is located at a predetermined first distance from a first point in which a direction change is intended; determining whether a lane in which the vehicle is located is identical to a lane in which a direction change to a direction desired at the first point is possible; and, when the vehicle is located at the first distance from the first point and the lane in which the vehicle is located is not the lane in which the direction change to the direction desired at the first point is possible, providing lane guidance information indicating a lane change to the lane in which the direction change to the direction desired at the first point is possible.

Here, the method may further comprise providing a user interface for receiving driving experience level information from a user; being provided with the driving experience level information through the user information; and determining the first distance based on the provided driving experience level information.

Also, in the determining the first distance, the first distance corresponding to the driving experience level information may be determined based on at least one of an expected arrival time from a current position of the vehicle to the first point and a distance between the current position of the vehicle and the first point.

Here, in the providing lane guidance information, it may be determined whether there are multiple lanes where the direction change to the direction desired at the first point is possible, and the land guidance information indicating a lane change to a lane corresponding to a direction desired at a second point in which a next direction change is intended may be provided when there are multiple lanes where the direction change to the direction desired at the first point is possible.

Here, in the providing lane guidance information, it may be determined whether a distance between the first point and the second point is less than a predetermined second distance, the lane guidance information indicating a lane change to a lane corresponding to the direction desired at the second point may be provided when the distance between the first point and the second point is less than the second distance and there are multiple lanes where direction change to the direction desired at the first point is possible.

According to the navigation apparatus and method having the above-described lane guidance function, a user interface screen in which a user can select driving experience level of the user is provided, and route guidance information can be provided based on the selected driving experience level so that navigation information can be provided more safely and accurately.

Specifically, driving information for intersection points and junction points can be notified to the user at a time corresponding to the user's driving experience level so that even drivers having low-level driving experience can drive a vehicle with higher psychological stability. Also, unnecessary information may not be provided to drivers having high-level driving experience so that convenience of route guidance may be enhanced.

In addition, lane change guidance information can be provided in consideration of the number of lanes and distances between intersection points thereby enabling users to drive more stably and efficiently in complex areas.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram to illustrate a user interface screen for receiving information on degree of user's driving experience according to an example embodiment of the present invention;

FIG. 2 is a flow chart to illustrate a method for providing navigation information according to an example embodiment of the present invention;

FIG. 3 is a flow chart to show an example of procedures for providing route guidance information illustrated in FIG. 2 in more detail;

FIG. 4 is a flow chart to show another example of procedures for providing route guidance information illustrated in FIG. 2 in more detail; and

FIG. 5 is a block diagram to show a configuration of a navigation apparatus according to the present invention.

### DESCRIPTION OF EXAMPLE EMBODIMENTS

Example embodiments of the present invention are described below in sufficient detail to enable those of ordinary skill in the art to embody and practice the present invention. It is important to understand that the present invention may be embodied in many alternate forms and should not be construed as limited to the example embodiments set forth herein.

Accordingly, while the invention can be modified in various ways and take on various alternative forms, specific embodiments thereof are shown in the drawings and described in detail below as examples. There is no intent to limit the invention to the particular forms disclosed. On the contrary, the invention is to cover all modifications, equivalents, and alternatives falling within the spirit and scope of the appended claims.

The terminology used herein to describe embodiments of the invention is not intended to limit the scope of the invention. The articles “a,” “an,” and “the” are singular in that they have a single referent, however the use of the singular form in the present document should not preclude the presence of more than one referent. In other words, elements of the invention referred to in the singular may number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art to which this invention belongs. It will be further understood that terms in common usage should also be interpreted as is customary in the relevant art and not in an idealized or overly formal sense unless expressly so defined herein.

In this specification, a GNSS means a global navigation satellite system, a positioning system using signals from satellites. For example, the GNSS may include GPS and other technologies similar to the GPS, such as GLONASS of Russia, Galileo of Europe, etc.

Also, a term ‘vision sensor’ used in this specification may mean one of sensors which can convert light signals into electric signals. That is, the vision sensor may be one of various sensors which can detect light signals in visible ray area. Also, the vision sensor may be referred to as ‘image sensor’, ‘visual sensor’, etc.

Hereinafter, embodiments of the present invention will be described in detail with reference to the appended drawings. In the following description, for easy understanding, like numbers refer to like elements throughout the description of the figures, and the same elements will not be described further.

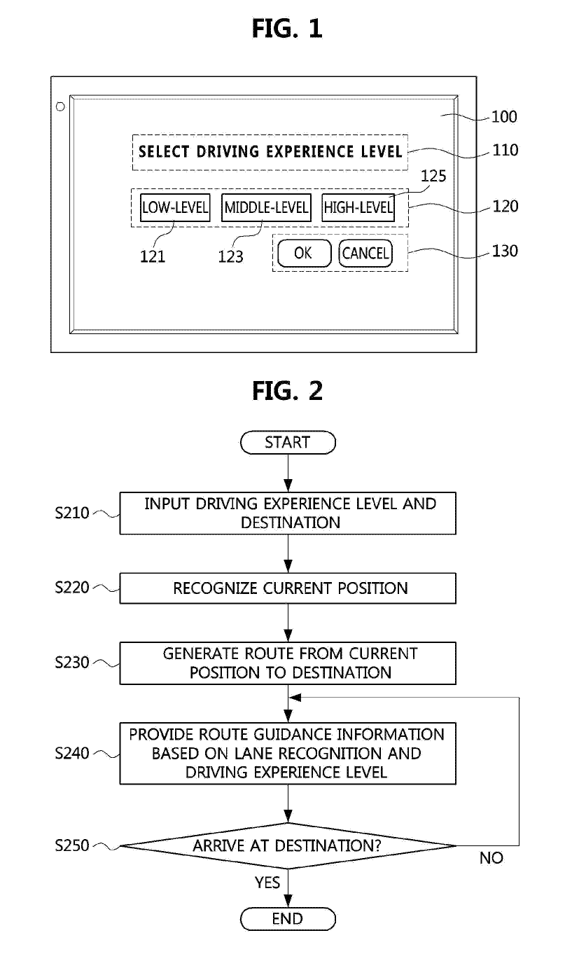

FIG. 1 is a conceptual diagram to illustrate a user interface screen for receiving information on degree of user's driving experience (i.e. driving experience level) according to an example embodiment of the present invention. That is, FIG. 1 is an example of a user interface screen 100 used for receiving information on degree of user's driving experience.

Referring to FIG. 1, a navigation apparatus according to the present invention may display the user interface screen 100 as shown in FIG. 1, when the navigation apparatus is activated by user's manipulation or supply of power, or when a key event for receiving the information is generated.

The user interface screen 100 may include a displayed text 110 instructing the user to input the degree of user's driving experience, driving experience level selection menus 121, 122, and 123, and a menu 130 indicating confirmation or cancellation of a selected menu.

The driving experience level selection menus 121, 122, and 123 may be displayed as the predetermined number of levels. For example, as shown in FIG. 1, one of low-level 121, middle-level 123, and high-level 125 may be selected by the user as the driving experience level. Alternatively, the driving experience level may be inputted by using an arbitrary value representing driving experience of the user.

Alternatively, various selection menus about driving career, driving distances, acquisition year of driver's license, etc. which can objectively represent the user's driving experience may be provided so that the navigation apparatus can determine the user's driving experience based on information inputted by the user through the selection menus. The information provided from the user in the above-described manner may be stored in a non-volatile memory device (e.g. flash memory) of the navigation apparatus, and then used for determining a lane change time when lane change guidance information should be provided to the user while guiding a driving route.

Here, the user interface screen may comprise the menu 130 which is used for the user to confirm or cancel information selected or inputted in the above-described driving experience level selection procedure.

FIG. 2 is a flow chart to illustrate a method for providing navigation information according to an example embodiment of the present invention. That is, FIG. 2 illustrates a method for providing route guidance information based on driving experience level of the user and a lane in which a vehicle on driving is located.

The navigation information providing method illustrated in FIG. 2 may be performed in a dedicated navigation apparatus or various terminals having navigation functions such as smartphones, etc. Hereinafter, for convenience of explanation, the apparatus performing the route guidance method illustrated in FIG. 2 will be referred to as a navigation apparatus.

Referring to FIG. 2, when the navigation apparatus is activated, the navigation apparatus may receive information on driving experience level and destination from a user. Here, the navigation apparatus may display the user interface screen as illustrated in FIG. 1, and receive the information on driving experience level of the user.

Also, although not separately illustrated, a user interface screen for inputting destination information may be displayed, and the destination information may be inputted through the displayed user interface screen.

The navigation apparatus may recognize a current position of it (i.e. a current position of a vehicle in which the apparatus is installed) by using at least one GNSS system (S220), and generate a route from the current position to the destination by using previously stored geographic information (or, electronic map) (S230). Also, the navigation apparatus may repeat the above position recognition step periodically until it arrives at the destination.

Then, in order to make the user drive the vehicle along the generated route, the navigation apparatus may provide route guidance information when the vehicle is located at a pre-configured distance (hereinafter, referred to as a ‘first distance’) from a point designated as a route guidance point (S240). Here, the route guidance point may be a point in which the vehicle should change its direction. For example, the route guidance points may be intersection points or junction points. In the present invention, the navigation apparatus may provide route guidance information by configuring the first distance differently according to the driver's driving experience level. The route guidance information may include guide information on areas around current position, direction guidance information for intersection or junction points, guide information on important points such as highway interchanges or service areas, guidance information on speed limits, lane change guidance information, etc. Here, the lane change guidance information may be provided through procedures for recognizing a lane in which the vehicle on driving is located and guiding a lane change based on the recognized lane.

Here, the first distance may be determined according to the degree of driving experience inputted by the user. That is, the first distance may be longer at lower degree of driving experience.

Also, the first distance may be determined based on at least one of an expected arrival time to the route guidance point and a distance to the route guidance point. For example, the first distance may be set to 500 meters for a user having low-level driving experience, and the first distance may be set to 200 meters for a user having high-level driving experience. Alternatively, the lane change guidance information for the user having low-level driving experience may be provided 30 seconds earlier than the expected arrival time, and the lane change guidance information for the user having high-level driving experience may be provided 10 seconds earlier than the expected arrival time.

Here, the expected arrival time may be calculated based on a current speed of the vehicle, a distance to the route guidance point, and a current position/time of the vehicle obtained from GNSS, or may be obtained from an external traffic information system through wireless communication networks.

The navigation apparatus may determine whether the vehicle arrives at the destination (S250). If the vehicle does not arrive at the destination, the route guidance information may be provided repetitively until the vehicle arrives at the destination (S240).

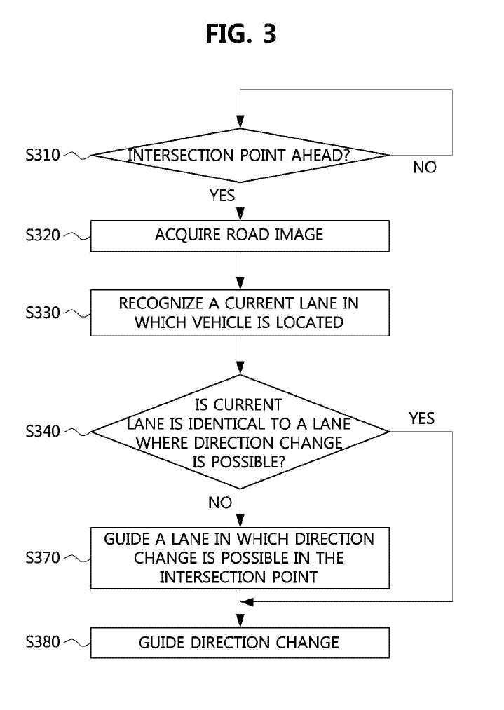

FIG. 3 is a flow chart to show an example of procedures for providing route guidance information illustrated in FIG. 2 in more detail. That is, FIG. 3 illustrates a procedure for recognizing a lane in which the vehicle on driving is located and guiding a lane change based on the recognized lane.

Referring to FIG. 3, the navigation apparatus may determine whether the vehicle is located at the first distance from a point where direction change is intended (hereinafter, referred to as ‘first point’) by using the GNSS system and the electronic map (S310). If it is determined that the vehicle is located at the first distance from the first point, the navigation apparatus may acquire an image about lanes in front of the vehicle on driving by using at least one vision sensor (S320).

Here, the point where direction change is intended may be referred to as a ‘direction change intended point’ at which direction change is intended. The direction change intended point may be a point which has two or more selectable directions, such as an intersection point, a junction point, etc.

Then, the navigation apparatus may recognize all lanes from the acquired image, and determine how many lanes exist in the left and right of the vehicle based on the recognized lanes (S330). That is, the navigation apparatus according to the present invention may recognize all lanes of a road in which the vehicle on driving is located, and recognize a lane in which the vehicle on driving is currently located among the recognized lanes.

It is explained that the step S320 is performed after the step S310 in FIG. 3. However, execution order of the steps is not restricted to the above explained example. For example, the step S320 is performed before the step S310, or they may be performed simultaneously. For example, the navigation apparatus may acquire the image about lanes without regard to vehicle position (S320), and then determine whether the vehicle is located at the first distance from the first point (S310).

Alternatively, the step S310 may be performed after the step S330. For example, the navigation apparatus may acquire the image about lanes without regard to vehicle position (S320), recognize a lane in which the vehicle on driving is currently located from the acquired image (S330), and determined whether the vehicle is located at the first distance from the first point (S310).

Then, the navigation apparatus may determine whether the lane in which the vehicle on driving is currently located is a lane where direction change is possible (S340). If the current lane is a lane where direction change is possible, direction change is guided to the user (S380). Otherwise, if the current lane is not a lane where direction change is possible, lane change is guided (S370), and then the direction change is guided (S380).

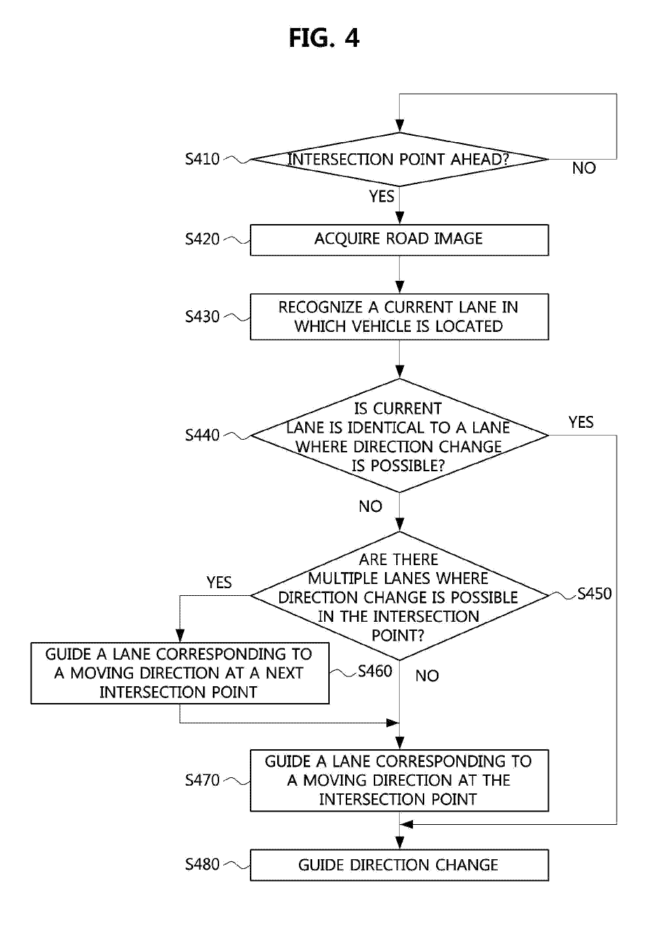

FIG. 4 is a flow chart to show another example of procedures for providing route guidance information illustrated in FIG. 2 in more detail. That is, FIG. 4 illustrates a procedure for providing lane guidance information when there are multiple lanes where direction change is possible at the point where direction change is intended.

Since steps S410 to S440 in FIG. 4 are identical to the steps S310 to S340 in FIG. 3, redundant explanation will be omitted.

After the step S440, the navigation apparatus may determine whether a lane in which the vehicle is currently located is a lane where a direction change to a direction desired at the first point is possible. If the current lane is determined as a lane where the direction change to the direction desired at the first point is possible, the direction change may be guided to the user (S480).

If it is determined that the current lane is not a lane where the direction change to the direction desired at the first point is possible, the navigation apparatus may determine whether there are multiple lanes where the direction change to the direction desired at the first point is possible (S450). If there are two or more lanes where the direction change to the direction desired at the first point is possible, a lane change to a lane corresponding to a moving direction desired at a next direction change intended point (hereinafter, referred to as ‘second point’) where direction change is intended is guided (S460).

For example, when the vehicle is expected to turn right at the first intersection point and turn left at the second intersection point, if two lanes from the right side of road are lanes where the right-turn is possible at the first intersection point, a lane change from the current lane to the second lane from the right side is guided. Also, for example, when the vehicle is expected to turn right at the first intersection point and turn right at the second intersection point, if two lanes from the right side of road are lanes where the right-turn is possible at the first intersection point, a lane change from the current lane to the first lane from the right side is guided. That is, when the lane guidance for the first intersection point is performed, a lane change to a lane which is suitable for preparing a direction change desired at the second intersection point may be guided in advance.

In the step S450, if there is only one lane where direction change is possible at the first point, a change to a lane corresponding to a moving direction desired at the first point is guided (S470).

Here, the step S450 may further comprise a step of determining whether a distance between the first point and the second point is less than a preconfigured distance (hereinafter, referred to as ‘second distance’). In this case, the navigation apparatus may perform the step S460 only when both of two conditions are satisfied (i.e. when the distance between the first point and the second point is less than the second distance and there are multiple lanes where direction change is possible). When at least one of the two conditions is not satisfied, the step S470 may be performed instead of the step S460.

When the current lane in which the vehicle is located is not a lane where direction change is possible, the navigation apparatus may guide lane change thorough the step S460 or S470, and then guide a direction change after performing the step S460 or the step S470 (S480).

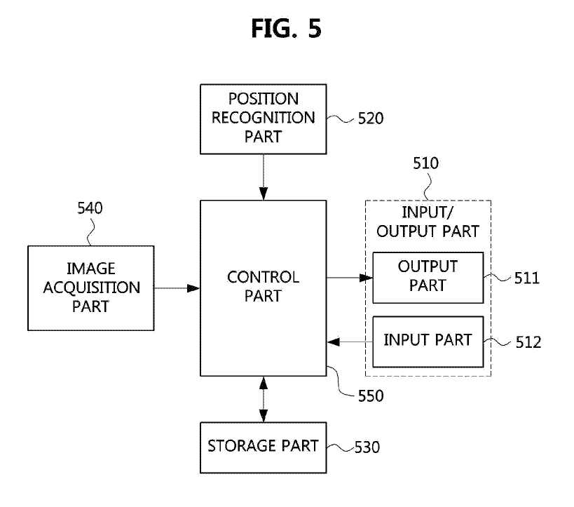

FIG. 5 is a block diagram to show a configuration of a navigation apparatus according to the present invention. That is, FIG. 5 illustrates a navigation apparatus which has a lane recognition function and provides lane change guidance information optimally according to user's driving experience level.

Referring to FIG. 5, the navigation apparatus according to the present invention may comprise an output part 511, an input part 512, a position recognition part 520, a storage part 530, an image acquisition part 540, and a control part 550.

The output part 511 displays a user interface screen for receiving information on a destination and user's driving experience level from a user and information provided by the control part 550.

Here, the user interface screen may be configured as shown in FIG. 1, and the information provided by the control part may include user's driving experience level, current position/speed of a vehicle, map about areas around the current position, route to the destination, direction change guidance information at direction change-intended point, and so on.

Here, the output part 511 may be configured with at least one of devices transferring visual information such as Liquid Crystal Display (LCD) and Organic Light Emitting Diodes (OLED) display devices, etc. and devices transferring audio information such as speakers, etc.

The input part 512 may be configured with at least one of text input means and audio input means, may be provided with information on the destination and driving experience level from the user, and may provide the control part 560 with the information.

Here, the textual input means may be configured with manipulation devices through which name, address, telephone number, map coordinate, etc. of the destination may be inputted. The manipulation devices may be configured as including various physical input means such as keypad, dial, touch screen, etc. The touch-screen type input part 512 may be configured as included in the output part 511. In this case, the input part 512 and the output part 511 may constitute an input/output part 510. When the input part 512 is configured with audio input means, audio sensor such as microphone, etc. may be included in the input part 512.

The position recognition part 520 may mean a part being provided with navigation signals from at least one of GNSS systems such as GPS, GLONASS, and Galileo. The position recognition part may be configured with an antenna receiving the navigation signals from satellites and a module which obtains position and time information from the received signals and provides the control part 550 with the obtained information.

Here, each component of the position recognition part 520 (e.g. the antenna and the module) may be configured as embedded in a main body of the navigation apparatus, or configured as a component which exists externally and is connected to other components of the navigation apparatus by using wireless or wired communications.

The storage part 530 may be configured with non-volatile memory devices, and store electronic maps (or, geographical information), data and program codes needed for operations of the navigation apparatus, etc. Especially, the storage part 530 may store information on driving experience level inputted to the control part 550 through the input part 512.

For example, the storage part 530 may be configured with various storage devices such as flash memory, magnetic disc, or optical disc. Here, the storage part may be configured with removable storage devices.

The image acquisition part 540 may be configured with at least one vision sensor, and acquire an image in front of a vehicle on driving. Specifically, the image acquisition part 540 may be configured to acquire an image about lanes of a road on which the vehicle on driving is located.

Here, the image acquisition part 540 may be configured as embedded in the main body of the navigation apparatus, or configured as a component which exists externally and is connected to other components of the navigation apparatus by using wireless or wired communications. For example, the image acquisition part 540 may be configured by using a sensor of other devices such as vehicle black box, smart phone, etc.

The control part 550 may be configured with at least one processing unit (e.g. a central processing unit, input/output processing unit, graphic processing unit, etc.). The control part 550 may control each of the components 510, 511, 512, 520, 530, and 540, and process information provided from each of the components. Specifically, the control part 550 may recognize lanes from the image acquired through the image acquisition part 540 and recognize a lane in which the vehicle on driving is currently located by counting the number of lanes which exist in the left and right side of the vehicle.

The control part 550 may store driving experience level information inputted through the input part 512 in the storage part 530. Also, the control part 550 may generate a route from the current position recognized through the position recognition part 520 to the destination inputted through the input part 512 based on the electronic map stored in the storage part 530.

The control part 550 may provide route guidance information based on the generated route. During the procedure of providing route guidance information, when the current position of the vehicle recognized through the position recognition part 520 is located at a first distance from a direction change intended point, if the current lane in which the vehicle is located is not a lane where direction change to an intended direction is possible, the control part 550 provides the output part 511 with lane change guidance information indicating a lane change to a lane where direction change is possible and direction change guidance information. Otherwise, if the current lane in which the vehicle is located is a lane where direction change to the intended direction is possible, the control part 550 provides only direction change guidance information.

Here, if there are two or more lanes where direction change is possible and a distance between the first point and a second point is less than a predetermined distance (a second distance), lane change guidance information indicating a lane change to a lane corresponding to a moving direction desired at the second point may be provided to the output part 511. That is, the lane change guidance information may indicate a lane change to a lane which is more suitable for preparing the direction change desired at the second point beforehand.

Here, the first distance may be determined based on at least one of a distance between the current position of the vehicle to the first point and estimated arrival time. Also, the first distance may be determined as a value inversely proportional to the user's driving experience level.

The control part 550 may provide the output part 511 with the information (e.g. driving experience level, current position/speed of the vehicle, map of areas around the current position, a route to the destination, etc.) provided from each of components of the navigation apparatus.

While the example embodiments of the present invention and their advantages have been described in detail, it should be understood that various changes, substitutions and alterations may be made herein without departing from the scope of the invention.

What is claimed is:

1. A navigation apparatus comprising:
an image acquisition part configured to acquire an image about lanes; and
a control part configured to recognize a lane in which a vehicle on driving is located and to provide lane guidance information based on the recognized lane and a configured driving route.

2. The navigation apparatus of claim 1, wherein, when the vehicle is located at a first distance from a first point in which a direction change is intended and the recognized lane is not a lane in which a direction change to a direction desired at the first point is possible, the control part provides lane guidance information indicating a lane change to the lane in which the direction change to the direction desired at the first point is possible.

3. The navigation apparatus of claim 2, further comprising an input/output part providing a user interface for receiving driving experience level information from a user according to control of the control part, wherein the first distance is determined according to the driving experience level information received through the input/output part.

4. The navigation apparatus of claim 3, wherein the control part determines the first distance corresponding to the driving experience level information based on at least one of an expected arrival time from a current position of the vehicle to the first point and a distance between the current position of the vehicle and the first point.

5. The navigation apparatus of claim 2, wherein the control part determines whether there are multiple lanes where the direction change to the direction desired at the first point is possible, and provides the lane guidance information indicating a lane change to a lane corresponding to a direction desired at a second point in which a next direction change is intended when there are multiple lanes where the direction change to the direction desired at the first point is possible.

6. The navigation apparatus of claim 5, wherein the control part determines whether a distance between the first point and the second point is less than a predetermined second distance, provides lane guidance information indicating a lane change to a lane corresponding to the direction desired at the second point when the distance between the first point and the second point is less than the second distance and there are multiple lanes where direction change to the direction desired at the first point is possible, and provides lane guidance information indicating a lane change to a lane corresponding to the direction desired at the first point when the distance between the first point and the second point is not less than the second distance and there is only one lane where direction change to the direction desired at the first point is possible.

7. A method for providing navigation information, the method comprising:
acquiring an image about lanes;
recognizing a lane in which a vehicle on driving is located from the image; and
providing lane guidance information based on the recognized lane and a configured driving route.

8. The method of claim 7, wherein the providing lane guidance information further comprises:
determining whether the vehicle is located at a predetermined first distance from a first point in which a direction change is intended;
determining whether a lane in which the vehicle is located is identical to a lane in which a direction change to a direction desired at the first point is possible; and
when the vehicle is located at the first distance from the first point and the lane in which the vehicle is located is not the lane in which the direction change to the direction desired at the first point is possible, providing lane guidance information indicating a lane change to the lane in which the direction change to the direction desired at the first point is possible.

9. The method of claim 8, further comprising:
providing a user interface for receiving driving experience level information from a user;
being provided with the driving experience level information through the user information; and
determining the first distance based on the provided driving experience level information.

10. The method of claim 9, wherein, in the determining the first distance, the first distance corresponding to the driving experience level information is determined based on at least one of an expected arrival time from a current position of the vehicle to the first point and a distance between the current position of the vehicle and the first point.

11. The method of claim 8, wherein, in the providing lane guidance information, it is determined whether there are multiple lanes where the direction change to the direction desired at the first point is possible, and the land guidance information indicating a lane change to a lane corresponding to a direction desired at a second point in which a next direction change is intended is provided when there are multiple lanes where the direction change to the direction desired at the first point is possible.

12. The method of claim 11, wherein, in the providing lane guidance information, it is determined whether a distance between the first point and the second point is less than a predetermined second distance, the lane guidance information indicating a lane change to a lane corresponding to the direction desired at the second point is provided when the distance between the first point and the second point is less than the second distance and there are multiple lanes where direction change to the direction desired at the first point is possible.
